(19) United States
(12) Patent Application Publication
(10) Pub. No.: US 2020/0072215 A1
(43) Pub. Date: Mar. 5, 2020

(54) ROTARY VANE VACUUM PUMP

(71) Applicant: Pfeiffer Vacuum GmbH, Asslar (DE)

(72) Inventor: Sebastian OBERBECK, Weilburg (DE)

(21) Appl. No.: 16/548,075

(22) Filed: Aug. 22, 2019

(30) Foreign Application Priority Data
Aug. 28, 2018 (EP) 18191276.7

(51) Int. Cl. F04C 2/344; C08F 214/26; F01C 21/08

(52) U.S. Cl. CPC F04C 2/3446; F04C 2220/12; F01C 21/0809; C08F 214/262

(57) ABSTRACT

The invention relates to a rotary vane vacuum pump comprising a housing member whose inner wall defines at least one pumping space, and a rotor that is arranged for rotation in the pumping space and has a rotor member and at least one vane, wherein the vane projects radially beyond the rotor member and together with the inner wall of the housing body a pumping volume that can be pumped by rotation of the rotor from an inlet to an outlet of the rotary vane vacuum pump, wherein the vane, at least in a region cooperating with the inner wall, comprises a polytetrafluoroethylene material containing polyimide particles and manufactured by hot pressing and sintering, and wherein the inner wall has a slide layer at least in a region cooperating with the vane, said slide layer comprising an oxide layer formed by anodic oxidation in an electrolyte including oxalic acid.

The present invention relates to a rotary vane vacuum pump comprising a housing member whose inner wall defines at least one pumping space, and a rotor that is arranged for rotation in the pumping space and has a rotor member and at least one vane, wherein the vane projects radially beyond the rotor member and defines a pumping volume together with the inner wall of the housing body that can be pumped by rotation of the rotor from an inlet to an outlet of the rotary vane vacuum pump.

Rotary vane vacuum pumps are very widespread due to their generally simple design and due to the small manufacturing costs associated therewith. Since the vanes permanently slide along the inner wall in operation, special measures are required to reduce friction. In the classical case, rotary vane vacuum pumps are operated with oil lubrication, i.e. a typically very large quantity of oil is present in the pumping space. This, on the one hand, requires a certain technical effort for the oil return and is problematic with respect to a possible reaction with a process gas, that is with a gas to be pumped, or also with respect to a possible contamination of a recipient, that is of a connected vacuum chamber. Other lubricants, typically liquid or pasty lubricants, are admittedly also used. However, they can also impair the process gas and the recipient.

Due to these disadvantages, so-called dry rotary vane vacuum pumps have been developed, i.e. an additional lubricant is dispensed with. The materials of the vanes and of the housing member are therefore selected such that they also have low friction without oil or the like so that heat development and wear are kept within a reasonable range. Vanes are thus frequently manufactured from plastic, graphite and/or composite materials, whereas the housing member and the rotor member are typically manufactured from iron materials, in particular cast iron. It is, however, common to the known systems that they substantially have low friction because a moisture film that acts in a lubricating and cooling manner forms on the friction partners due to the generally present humidity. Such a moisture film is, however, lost when the pressure in the pump falls below the water vapor pressure of approximately 25 hPa since then the total water in the air is only present as vapor. Without the moisture film, friction rises greatly so that the friction partners can wear in a very short time. For this reason, such pumps typically have a vapor pressure safety valve that vents the pumping space before the water vapor pressure is fallen below. Extensive operating safety can admittedly hereby be ensured. The known dry rotary vane vacuum pumps are, however, therefore limited in the achievable pressure, also called the end pressure; in practice, even typically to an even higher pressure of approximately 100 hPa. There is no such limit with oil-lubricated pumps. A so-called fine vacuum can even be reached.

For the aforesaid reasons and in particular due to the cost advantages with respect to other kinds of pumps such as scroll pumps, the oil-lubricated rotary vane vacuum pump is extremely widespread. It so-to-say forms the classical case of a vacuum pump. The disadvantages of oil lubrication are admittedly known, but they are not questioned in the technical world. For different kinds of pump such as scroll pumps exist for special application cases in which, on the one hand, a fine vacuum has to be provided and, on the other hand, a contact of the process gas with oil has to be avoided. For all the other simpler application cases, however, the oil-lubricated rotary vane vacuum pump has been the proven solution for more than 100 years.

In light of this prejudice that is predominant in the technical world, the inventor has set himself the object of providing a dry rotary vane vacuum pump having an improved end pressure by means of which a fine vacuum can in particular also be generated.

This object is satisfied by a rotary vane vacuum pump having the features of claim 1 and in particular in that, at least in a region cooperating with the inner wall, the vane comprises, and in particular completely consists of, a polytetrafluoroethylene material containing polyimide particles and manufactured by hot pressing and sintering and in that the inner wall has a slide layer at least in a region cooperating with the vane, in particular with its region, said slide layer comprising an oxide layer formed by anodic oxidation in an electrolyte containing oxalic acid.

A solution was found with this combination of friction partners having such a low friction even without moisture films that the rotary vane vacuum pump equipped therewith can also be operated below the water vapor pressure without any additional lubricant, in particular a liquid lubricant. The operating range of dry rotary vane vacuum pumps has consequently been substantially increased by the invention and the cost benefits of rotary vane vacuum pumps in the fine vacuum sector have been associated with the possibility of dry operation in an unimagined manner.

This is in particular due to the properties of the polytetrafluoroethylene material that is used in accordance with the invention for the vane or for its region, that contains polyimide particles, and that is manufactured by means of hot pressing or injection molding or extrusion molding and is additionally subjected to a sintering process. The vane has very high shape stability and thus wear resistance, also at elevated temperatures, which is due, on the one hand, to the very low porosity and, on the other hand, to the finely distributed, non-agglomerated polyimide particles.

Particular advantages result in combination with the properties of the oxide layer formed by hard anodic oxidation in an oxalic axis electrolyte that is in particular cold.

In comparison with oxide layers that are produced in a sulfuric acid electrolyte, the layers in accordance with the invention have a very small layer thickness tolerance that is in a range of a maximum of ±5 μm, in particular at approximately ±3 μm. This means that the oxide layer formed has a very planar surface, from which an exact seal in combination with the vane in accordance with the invention results, on the one hand, and a low friction, on the other hand since fewer irregularities have to be overcome on a movement of the two friction partners relative to one another.

In addition, the slide layer only shows a small edge effect. This relates to bone-like bell-mouth formations at the edges of the layer that prevent an exact positioning of the vane on the slide layer required for an ideal seal. Since the bell-mouth formations are generally irregularities, they likewise increase the friction during the movement of the two friction partners relative to one another. The small edge effect accordingly also produces a particularly small wear rate of both the slide layer and of the vane in combination with the shape stability of the vane in accordance with the invention.

A fine vacuum is here considered as a vacuum having a pressure between 1 and 10⁻³ hPa.

Provision is made in accordance with an advantageous embodiment that at least substantially the total inner wall defining the pumping space has the slide layer. Not only friction is hereby reduced overall, but rather the manufacture of the slide layer is also simplified since it does not have to be precisely applied at spots, but can rather be applied globally, for example in an oxalic acid bath. Alternatively or additionally, the vane can in particular be completely manufactured from the polytetrafluoroethylene material. Such a vane can be produced inexpensively, but has particularly low friction at all the regions cooperating with other components.

In a further embodiment, the vane is displaceably, in particularly radially, supported in the rotor member, wherein, at least in a region cooperating with the rotor member, the vane comprises a polytetrafluoroethylene material that contains polyimide particles and is manufactured by hot pressing and sintering, and wherein, at least in a region cooperating with the vane, in particular its region, the rotor member has a slide layer that comprises an oxide layer formed by anodic oxidation in an electrolyte containing oxalic acid. Friction, heat development, and wear are hereby even further reduced in the pump.

To the extent reference is made herein to a radial direction, either, for example, with respect to the fact that the vane radially projects beyond the rotor member or that the vane is radially displaceable, this is not necessarily to be understood as a strictly radial alignment with respect to an axis of rotation, but rather only as at least a radial component. I.e. the vane can e.g. also be displaceable along an axis that does not intersect the axis of rotation of the rotor as long as a radial component of the vane extends at least at times beyond the rotor member that is typically formed as substantially circularly cylindrical.

The vane can be held in contact e.g. with the inner wall by its centrifugal force as a result of a rotation of the rotor and/or by a preload, for example by means of a spring.

In an advantageous further development, the rotor member has a guide for the vane and the cooperating regions of the vane and the inner wall are cooperating guide regions. The service life of the pump can hereby be yet further improved.

Alternatively or additionally, the rotor member, for example, has an abutment for the vane and the regions are cooperating abutment regions. The service life of the pump is hereby yet further improved. Both guide regions and abutment regions having a material pairing in accordance with the invention can in particular be provided.

The vane can generally, for example, be supported in a recess of the rotor member, with in particular a base of the recess forming an abutment for the vane. A vane can, for example, also be formed continuously by the rotor and/or can be displaceably supported in the rotor without an abutment.

Provision is made in accordance with a further development that a closure wall is provided that extends transversely, in particular at least substantially perpendicular, to an axis of rotation of the rotor and/or that axially bounds a respective pumping volume, wherein, at least in a region cooperating with the closure wall, in particular an axial end region and/or an end face of the vane, the vane comprises a polytetrafluoroethylene material containing polyimide particles and manufactured by hot pressing and sintering, and wherein, at least in a region cooperating with the vane, in particular its region, the closure wall has a slide layer that comprises an oxide layer formed by anodic oxidation in an electrolyte containing oxalic acid.

The closure wall can, for example, be formed as part of the housing member. The and/or a second closure wall can, however, for example, also be formed by a component, in particular a closure element and/or a support plate, separate from the housing member. A combination thereof is in particular advantageous, that is that a closure wall is formed for a pumping space or for a pumping volume in one part with the housing member and a second closure wall is formed as a separate component, wherein in particular both closure walls have the slide layer at least in the region cooperating with the vane.

In a particularly advantageous embodiment, the closure wall is formed in one part with the housing member, with the slide layers of the closure wall and of the inner wall being seamlessly adjacent. An extremely low friction with the vane is hereby achieved with nevertheless good sealing and a correspondingly good pump performance. A member edge or corner of the housing member is here not to be seen as a seam as long as a slide layer is also present there. Alternatively or additionally, the slide layers can be particularly easily manufactured in a common layer-generating method step, for example in that the inner wall and the closure wall are simultaneously oxidized in an oxalic acid bath.

In an embodiment, the polytetrafluoroethylene material of the vane has a proportion of polyimide particles between 1 and 25 wt. %, preferably between 5 and 20 wt. %, particularly preferably between 7 and 15 wt. %, and in particular between 8 and 12 wt. %. The figures refer to the dry weight of the material.

In a further embodiment, the polyimide particles have a mean particle size between 1 and 50 μm, preferably between 5 and 40 μm, particularly preferably between 10 and 30 μm, in particular between 15 and 25 μm.

The determination of the particle size takes place by means of laser light scattering or laser diffraction. The determination of the particle size furthermore takes place by measurement of scanning electron microscopic recordings.

The polyimide particles are in particular present in a finely distributed and substantially non-agglomerated form in the polytetrafluoroethylene material. “Substantially” should here be understood such that only a very small number of polyimide particles are present in agglomerates of more than two polyimide particles in the material. In other words, the polyimide particles are homogeneously embedded in a matrix of polytetrafluoroethylene, with no agglomerates of more than two polyimide particles occurring. The determination of the number of agglomerates takes place by evaluation of scanning electronic microscopic recordings.

It is furthermore particularly advantageous if the polytetrafluoroethylene material has a porosity between 0.1 and 5%, preferably between 0.1 and 2%, particularly preferably of less than 1%. The determination of the porosity takes place, on the one hand, by means of light microscopic recordings and, on the other hand, by means of electronic microscopic recordings.

The homogeneous distribution of the polyimide particles in the polytetrafluoroethylene matrix and the low porosity of the polytetrafluoroethylene material are in particular responsible for its wear resistance. Both parameters can be controlled by the hot pressing method in which the raw material of the polytetrafluoroethylene material is directly heated in a tool heated in a regulated manner and under pressure and by the subsequent sintering method. If the porosity amounts to less than 1%, the polytetrafluoroethylene materials can have a density of up to 2.10 g/cm³.

In a further embodiment of the pump in accordance with the invention, the slide layer has a layer thickness between 10 and 50 μm, preferably between 15 and 40 μm, and particularly preferably between 20 and 30 μm. The determination of the layer thickness takes place with reference to electron microscopic sectional recordings.

In a particularly advantageous embodiment, the slide layer is additionally impregnated with a dry lubricant, in particular polytetrafluoroethylene. The dry lubricant is here incorporated in the layer and no additional layer build-up takes place. The dry lubricant in conjunction with the polytetrafluoroethylene material of the vane effects an improved sliding behavior and thus reduces friction. The incorporation of a dry lubricant provides the further advantage that the slide properties are substantially maintained on an abrasive wear of the slide layer.

It can equally be preferred that the slide layer is coated with a dry lubricant, in particular with polytetrafluoroethylene, with an additional layer build-up occurring here. The additionally applied dry lubricant improves the dry lubricating properties of the slide layer and increases its service life. Polytetrafluoroethylene has anti-adhesive properties and thus facilitates the cleaning of the slide layer surface.

Alternatively, the slide layer can also be post-treated with saline solutions or with hot, in particular desalinated, water. Such a treatment wears the pores in the slide layer and increases its corrosion resistance.

The slide layer preferably has an apparent hardness between 400 and 600 HV 0.025, in particular between 500 and 550 HV 0.025. The measurement of the hardness takes place according to the Vickers hardness test (HV). An indenter in the form of a straight pyramid is pressed at a predefined test force in a perpendicular manner into the surface of the respective sample. Since the base surface of the pyramid is square, the Vickers hardness can be calculated from the area of the test impression. Measurement is made with a test force of 0.2452 Newtons (HV 0.025) in the present case. Since the slide layer can, as described above, have a porosity between 0.1 and 5%, the hardness is also called an apparent hardness or intermediate hardness in the present case.

The apparent hardnesses of conventional layers, in particular layers formed by anodic oxidation in an electrolyte containing sulfuric acid, are as a rule lower by at least 50 HV 0.025. A higher wear resistance results from a higher apparent hardness. This was able to be shown in a Taber abraser test with which the wear resistance of different materials can be determined. In the test, the wear strain is produced by two abrasive wheels that are pressed onto the rotating specimen at a fixed force. The slide layer in accordance with the invention only shows a wear of 12.5 μm at a force of 10 N (abrasive wheel CS 10) after more than 90,000 rotations of the specimen. Conventional layers already showed this wear after 60,000 rotations under the same conditions.

The chemical resistance of the layer in accordance with the invention improved in comparison with conventional layers, in particular layers formed by anodic oxidation in an electrolyte containing sulfuric acid, was able to be demonstrated using the salt spray mist test. This is a standardized test in accordance with DIN EN ISO 9227 for assessing the corrosion protection effect of coatings. With the layer in accordance with the invention, first determinable corrosion phenomena, however, only appeared after more than 2000 hours of residence time while conventional layers already showed them after half the time.

The coefficient of friction of the slide layer preferably amounts to less than 0.9, particularly preferably less than 0.8, in particular approximately 0.73, with the determination of the coefficient of friction taking place using a pin on disk tribometer. The contact pressure of the tribometer here amounted to 5 Newtons at a speed of 6 m/min and 9000 r.p.m.

The slide layer has a very high surface quality. The surfaces movable with respect to one another in vacuum pumps typically have a roughness average Ra without the slide layer in accordance with the invention of approximately 0.2 μm and an averaged roughness depth Rz of approximately 1.4 μm. A slide layer in accordance with the invention having a typical layer thickness of approximately 20 μm is now in particular characterized in that the mean roughness average Ra increases after the application of the slide layer by no more than 1.0 μm, preferably approximately 0.5 μm. With conventional layers, the increase of the mean roughness average Ra is typically at least 1.5 μm. The averaged roughness depth Rz preferably increases after the application of the slide layer having a layer thickness of approximately 20 μm by less than 0.3 μm, particularly preferably by less than 0.2 μm, in particular by less than 0.1 μm. The averaged roughness depth Rz typically increases by at least 0.3 μm in conventional layers of a comparative thickness.

Provision is made in accordance with a further embodiment that, in each case at least in the region of the slide layer, the housing member, the inner wall, the rotor member and/or the closure wall each comprises/comprise a base material that is formed at least partly from aluminum or from an aluminum alloy and onto which the slide layer is applied. These parts preferably consist of aluminum or of an aluminum alloy. The base material is particularly preferably an aluminum alloy of the type AlMgSi. Aluminum alloys of the type AlMgSiMn, AlMgSiPb or AlZnMg are further advantageous. Aluminum and aluminum alloys have proved to be particularly suitable to be subjected to an anodic oxidation in an electrolyte containing oxalic acid and to form a slide layer in accordance with the invention.

In an advantageous further development, the rotary vane vacuum pump has a temperature regulation device for the pumping space. It can, for example, be configured as a cooling and/or heating device, have heat transfer ribs and/or air and/or water as the heat transfer medium, and/or can be configured as active or passive.

The friction can be further reduced and the service life of the friction partners or of the pump can be further improved in that e.g. the temperature regulation device is configured to keep the temperature of the inner wall, of the rotor member, of the closure wall and/or of the vane within a temperature range in operation, with an upper limit of the temperature range amounting to at most 100° C., in particular at most 80° C., in particular at most 60° C., and in particular at most 58° C., and/or with a lower limit of the temperature range amounting to at least 20° C., in particular at least 30° C., in particular at least 40° C., and in particular at least 45° C. A temperature range from 45° C. to 60° C. is particularly advantageous. The temperature regulation device can, for example, be constructionally adapted to the temperature range. Alternatively or additionally, a control can be provided for a temperature regulation device that is in particular active and the control can be configured to keep within the temperature range. For this purpose, for example, a temperature sensor can also be provided, in particular in or at the housing member and/or in or at the closure wall. Even if the temperature regulation device is configured for keeping the temperature range, it can, however, in particular occur under special conditions that the temperature range is departed from. However, a temperature range that is targeted in a construction and/or technical control manner, as specified, is decisive.

It is particularly advantageous if the temperature regulation device has a heating device, with the heating device and/or a control device therefor being configured to heat the temperature at the said component or components to a temperature in the desired temperature range, in particular in a heating-up phase prior to an operating phase. Friction and wear can hereby be further reduced.

In a further embodiment, the rotor is supported at at least one side, in particular at two or both sides, by a plain bearing, in particular by a plastic plain bearing. The risk of a chemical interaction between the pump and the process gas and the possibility of contamination of the recipient are hereby further reduced. The storage is in particular free of liquid lubricants or of lubricants not otherwise firmly embodied.

It is particularly advantageous if the rotary vane vacuum pump is configured with two or more stages, i.e. has two pumping spaces having vanes active therein. A particularly low end pressure can hereby be achieved with low friction and good service life in accordance with the invention. In this respect, a first pumping space in the direction of pumping is in particular equipped with the material pairing in accordance with the invention of the friction partners. Costs for the configuration of the slide layer and of the vane material can hereby be saved and a good pump performance, that is in particular a relatively low end pressure, can nevertheless be achieved. A particularly low end pressure is achievable when both stages, at least two of a plurality of stages, or all the stages or pumping spaces are configured with the friction pairing in accordance with the invention.

The rotary vane vacuum pump can advantageously be exclusively configured for dry running. The pump is in particular free of liquid lubricant or of lubricant otherwise not firmly embodied, in particular oil, in the pumping space, in a lubrication system and/or in a lubricant return device.

The rotary vane vacuum pump can, for example, also be configured as a free of a vapor pressure safety valve, which saves manufacturing costs.

The object of the invention is satisfied by a method, currently not separately claimed, that serves for the manufacture of a rotary vane vacuum pump that has a housing member whose inner wall defines at least one pumping space, that has a rotor that is arranged for rotation in the pumping space and that has a rotor member and at least one vane, wherein the vane projects radially beyond the rotor member and defines a pumping volume with the inner wall of the housing body that can be pumped by rotation of the rotor from an inlet to an outlet of the rotary vane vacuum pump. In this process, at least in a region cooperating with the inner wall, the vane is manufactured from a polytetrafluoroethylene material containing polyimide particles and manufactured by hot pressing and sintering and a slide layer is applied to the inner wall at least in a region cooperating with the vane, said slide layer comprising an oxide layer formed by anodic oxidation in an electrolyte containing oxalic acid.

The object is also satisfied by a use, currently not separately claimed, of a dry rotary vane vacuum pump for generating a fine vacuum, in particular at a pressure below 10⁻¹ hPa, in particular below 10⁻² hPa, with the pump having the features of the rotary vane vacuum pump in accordance with the invention.

The pump in accordance with the invention, the method in accordance with the invention, and the use in accordance with the invention can naturally be advantageously further developed in the sense of the embodiments of the respective other aspects described herein.

The invention will be explained only by way of example in the following with reference to the schematic drawing.

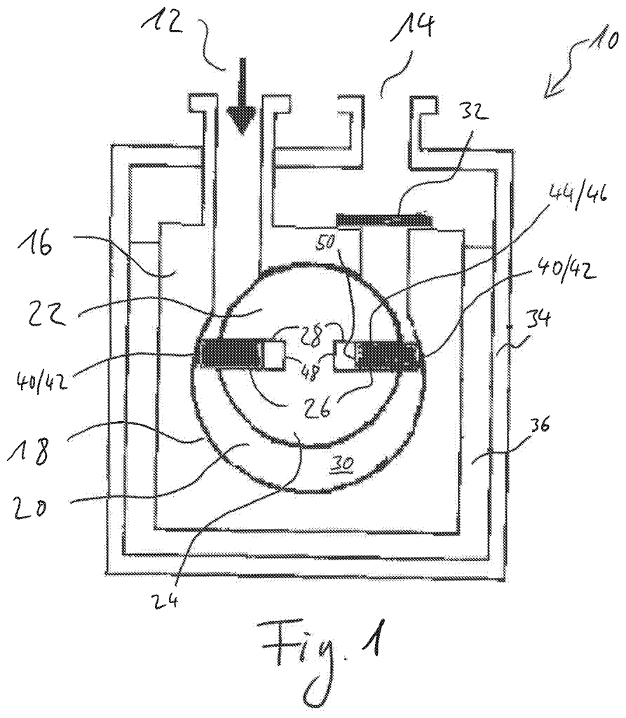

FIG. 1 shows a schematic diagram of a rotary vane vacuum pump of the prior art;

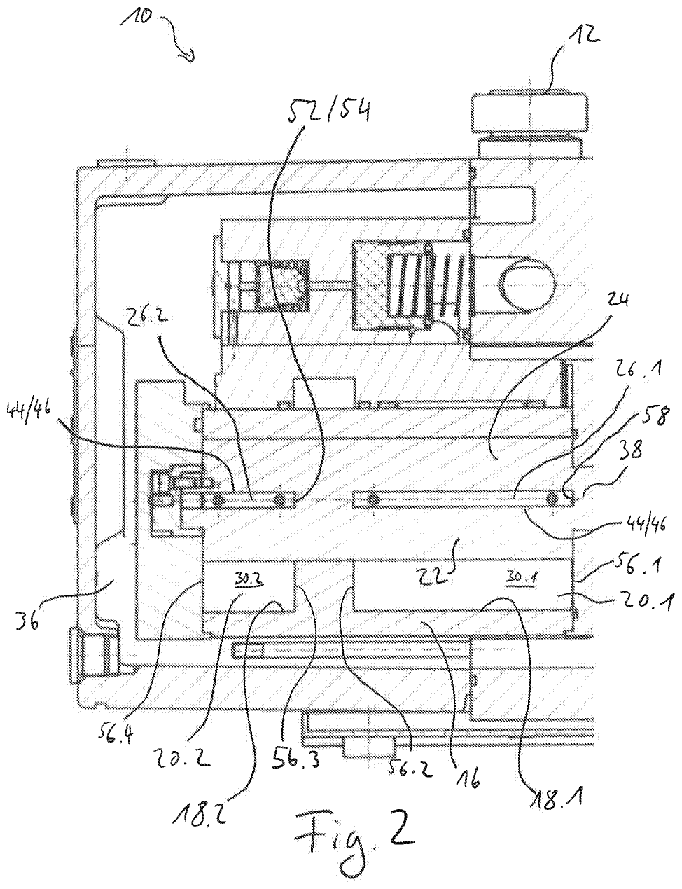

FIG. 2 shows a rotary vane vacuum pump of the prior art in a sectional representation;

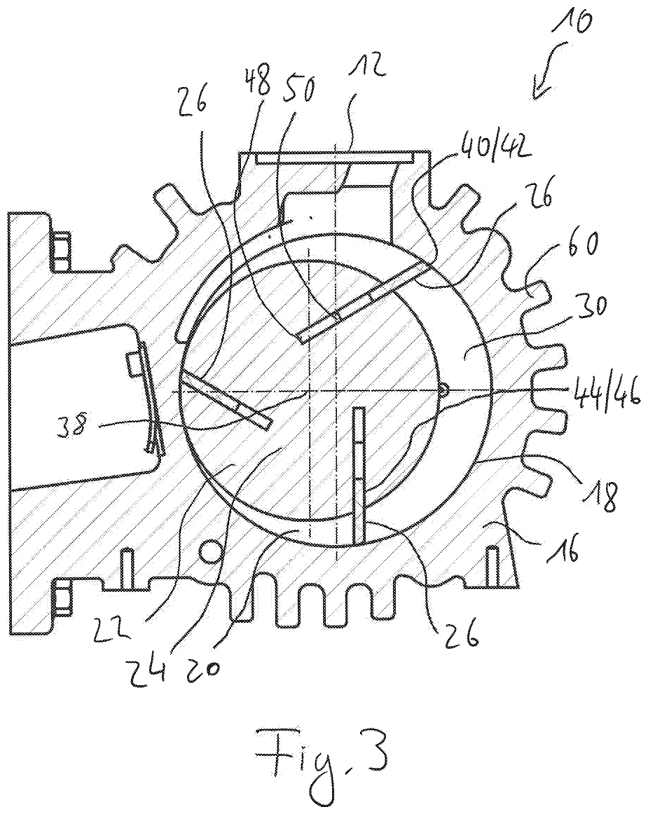

FIG. 3 shows a further rotary vane vacuum pump in a sectional representation; and

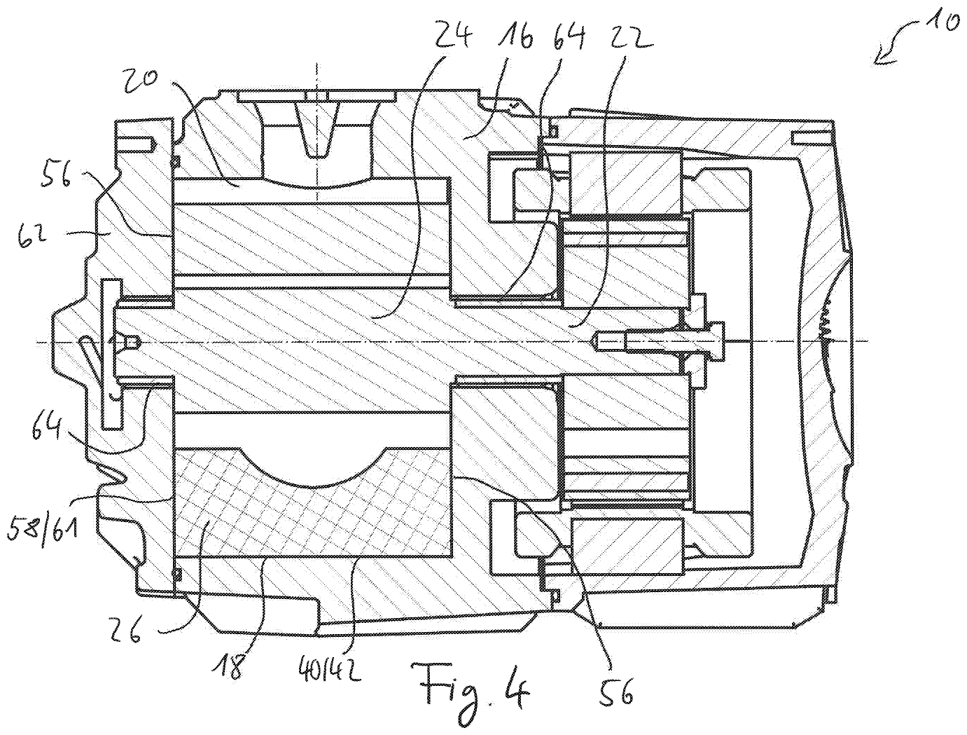

FIG. 4 shows the pump of FIG. 3 in a longitudinal section.

The rotary vane vacuum pump 10 of the prior art shown in FIG. 1 comprises an inlet 12 via which a process gas enters in operation of the pump 10 as indicated by an arrow. The process gas is pumped to an outlet 14 by the pump 10.

The rotary vane vacuum pump 10 additionally comprises a housing member 16 whose inner wall 18 defines a pumping space 20 for the process gas. A rotor 22 is arranged for rotation in the pumping space 20 and comprises a rotor member 24 and two vanes 26. The vanes 26 are each displaceably supported in a recess 28 of the rotor member 24 and are radially outwardly preloaded and thus preloaded against the inner wall 18 by a spring, not shown, at the recess base. The rotor 22 is arranged eccentrically toward the inner wall 18 of the housing member 16 so that on a rotation of the rotor, the vanes 26 are displaced in the recesses 28, but maintain contact with the inner wall 18.

The vanes 26 project radially beyond the rotor member 24 and together with the inner wall 18 of the housing member 16 define a pumping volume 30 that can be pumped from the inlet 12 to the outlet 14 by rotation of the rotor 22. The rotor 22 rotates in this process counterclockwise with respect to FIG. 1.

An outlet valve 32 is provided in front of the outlet 14 in the pumping direction and prevents a backflow of the process gas into the pumping space 20, for example on a functional problem and/or a standstill of the pump 10. A valve can alternatively or additionally also be provided at the inlet 12.

The vacuum pump 10 further comprises an outer housing 34 that comprises an oil chamber 36 that is filled with oil for lubricating the pump 10. The oil chamber 36 is in fluidic contact (not shown) with the pumping space 30 and thus provides a lubrication of the rotor 22 in the pumping space 30. It is therefore here the initially described classical case of a rotary vane vacuum pump by means of which a fine vacuum can admittedly generally be achieved. The oil can, however, result in an unwanted chemical reaction with the process gas and/or in a contamination of a recipient (not shown) connected to the inlet 12.

A rotary vane vacuum pump 10 of the prior art is shown in FIG. 2. The same reference numerals are used herein for corresponding features, with the corresponding features also being able to be differently configured. The longitudinal section of FIG. 2 has a sectional plane that extends along an axis of rotation 38 of a rotor 22 of the pump 10.

The pump 10 comprises an inlet 12 and an outlet that is not visible due to the selected sectional plane. Two pumping spaces 20.1 and 20.2 are provided in the pumping direction between the inlet 12 and the outlet and are each defined by an inner wall 18.1 and 18.2 respectively of a housing member 16.

The rotor 22 comprises a rotor member 24 and vanes 26.1 and 26.2 that rotate in the corresponding pumping spaces to pump the process gas. The rotor 22 can, for example, also have at least one further vane 26, in particular per pumping space 20.

The pump 10 of FIG. 2 also has an oil chamber 36 for providing a lubricating oil. The invention can nevertheless be further illustrated in the following with reference to FIG. 2 and also with reference to FIG. 1.

With reference to FIG. 1, in accordance with the invention at least one of the vanes 26 is formed at a region 40 cooperating with the inner wall 18 such that it comprises a polytetrafluoroethylene material containing polyimide particles and manufactured by hot pressing and sintering. At least in a region 42 cooperating with the region 40 of the vane 26, the inner wall 18 has a slide layer that comprises an oxide layer formed by oxidation in an electrolyte containing oxalic acid. This material combination of the friction partners enables particularly low friction so that an oil lubrication and an oil chamber 36 can in particular be dispensed with. The described slide layer is in particular applied to the total inner wall 18, that is in particular cylindrical, of the housing member 16. The low friction is thus implemented over the total friction path described by the vane 26 at the inner wall 18 and the slide layer can additionally be applied advantageously, inexpensively, and particularly homogeneously.

The friction can be further minimized in that, for example, the rotor member 24 has the slide layer in accordance with the invention at a guide region 44 for the vane 26, with the vane 26 comprising the polytetrafluoroethylene (PTFE) material in accordance with the invention at a corresponding guide region 46. This can advantageously also be provided in the other vane 26 or at an oppositely disposed guide region for which this is not separately referenced for reasons of clarity.

The rotor member 24 comprises an abutment having an abutment region 48 that can advantageously be provided with the slide layer in accordance with the invention. A corresponding abutment region 50 of the respective vane 26 comprises the PTFE material in accordance with the invention. Friction and wear are thus also reduced here. The total vane can in particular be manufactured from the PTFE material in accordance with the invention.

Guide regions 44 and 46 of at least one vane 26 or of the vanes 26 can also be equipped with the material pairing in accordance with the invention in the pump 10 shown in FIG. 2. The respective inner wall 18 can have the described slide layer with the advantages in accordance with the invention. A region of the respective vane 26 cooperating therewith is not visible in FIG. 2, but advantageously comprises the described PTFE material.

A further pair of cooperating guide regions 52 and 54 of the vane 26 and the rotor member 24 is visible in FIG. 2 and can likewise comprise the material pairing in accordance with the invention. While the guide regions 44 and 46 extend in the longitudinal direction, the guide regions 52 and 54 are formed at respective axial end regions of the vane 26 or rotor member recess.

Closure walls 56 for the pumping spaces 20 are visible in the longitudinal section shown in FIG. 2. They each axially bound the respective pumping volumes 30. A closure wall 56.1 is formed by a component that is separate from the housing member 16 and that also forms a support for the rotor 22 in this embodiment. A second closure wall 56.2 is formed in one part with the housing member 16. The closure walls 56.1 and 56.2 together axially bound a pumping volume 30.1. The pumping volume 39.1, as also the pumping volume 30.2, is radially bounded by the inner wall 18 and by the rotor member 24. The respective pumping volume 30 is bounded by the vane or vanes 26 in the peripheral direction. A respective closed pumping volume 30 is hereby defined that is pumped from the inlet 12 to the outlet by rotation of the rotor 22.

In a similar manner to the closure walls 56.1 and 56.2, the closure walls 56.3 and 56.4 are likewise formed in one part with or separately from the housing member 16, with other constructions also being possible.

At least one of the closure walls 56 can advantageously be equipped with the slide layer in accordance with the invention. A vane 26 here advantageously comprises the PTFE material in accordance with the invention at least in a region 58 cooperating with the closure wall 56. The friction is thus minimized at a further position and the leak tightness, service life, and pump power of the pump 10 are improved overall. The further closure walls 56.2, 56.3, and 56.4 and the respective regions of the respective vane 26 cooperating herewith, but not separately referenced, can be equipped with the material pairing in accordance with the invention to further reduce the friction.

In a further embodiment, the housing member 16, the rotor member 22 and/or the separate components forming the closure walls 56.1 and 56.4 are configured such that they comprise aluminum or an aluminum alloy as the base material at least in the regions cooperating with at least one of the respective vanes 26. Not only the total weight of the pump 10 is hereby reduced, but a particularly advantageous base material for the respective slide layer is also provided.

It also applies to the pump 10 of FIG. 2 that the oil chamber 36 or the lubrication oil and/or further parts of a liquid lubrication system can now be omitted. This not only saves the costs associated therewith, but also enables completely new application areas of the rotary vane vacuum pump 10 that in particular has two stages. The features described here are admittedly not restricted to a two-stage rotary vane vacuum pump, but they can develop further or improved advantages in same. A particularly low end pressure is in particular hereby achievable, with a contamination of process gas and/or recipient being avoided.

FIG. 3 shows a rotary vane vacuum pump 10 in accordance with the invention in a cross-section. A rotor 22 of the pump 10 comprises a rotor member 24 and, in this embodiment, three vanes 26. The vanes 26 are arranged distributed over the periphery of the rotor member 24 and are radially displaceably supported in respective recesses of same. In this embodiment, the vanes 26 are furthermore formed at a slant with respect to the periphery of the rotor member 24. Their connection axes do not intersect the axis of rotation 38 of the rotor 22. Respective sections of the vanes 26 projecting radially beyond the rotor member 24 bound a pumping volume 30 in the peripheral direction.

Regions 40 and 42 having the material pairing in accordance with the invention are provided at the vane 26 and at the inner wall 18. In addition, this material pairing can be provided at guide regions 44, 46 and/or at abutment regions 48, 50 of the vane 26 or rotor member 24.

The housing member 16 has a temperature regulating device formed as a cooling device. The cooling device comprises a plurality of cooling ribs 60 by means of which heat can be led off from the pumping space 20 and from the housing member 16. The cooling device can, for example, be constructionally adapted to maintain the temperature of the inner wall 18 and/or of other pump-active components in a temperature range in operation. The cooling device can, for example, comprise a fan, not shown, that is it can be configured as active. Alternatively or additionally, for example, a liquid temperature regulating device can be provided.

The rotary vane vacuum pump 10 of FIG. 3 is shown in a longitudinal section in FIG. 4. The rotor 22 with the rotor member 24 and with one of the vanes 26 can inter alia be seen as well as a housing member 16 whose inner wall 18 defines a cylindrical pumping space 20 in which the rotor 22 for pumping a process gas can rotate.

As can be seen in FIG. 4, the pump 10, unlike that of FIG. 2, is a single-stage rotary vane vacuum pump having only one pumping space 20. The latter is axially bounded by closure walls 56 of which in turn one, the left one in FIG. 4, is formed by a separate component and one, the right one in FIG. 4, is connected to the housing member 16 in one part.

As already stated with respect to FIG. 4, the vane 26 has the PTFE material in accordance with the invention at a region 40 that slides along a region 42 of the inner wall 18 in operation, while the inner wall 18 has the slide layer in accordance with the invention in the corresponding region 42. The material pairing in accordance with the invention composed of the PTFE material and the slide layer is also provided at a region 61 of the vane 26 or a region 58 of the closure wall 56.

The rotor 22 is advantageously supported at at least one side, here at two sides, by the component forming the closure wall 56. They are here in particular a separate support plate 62 and/or a support region of the housing member 16.

The rotor 22 can, in accordance with FIG. 4, be supported for a further friction reduction and for an avoidance of lubricants at at least one side, here at two sides, by a plain bearing that is in particular formed as a plastic plain bearing.

The vacuum pumps shown are optimized in a technical friction manner at a number of points in comparison with the prior art. A rotary vane vacuum pump for providing a fine vacuum in dry operation can hereby be implemented overall with a good service life and little wear. Before knowing of the invention, there was apparently no need in the technical word for a dry rotary vane vacuum pump in the fine vacuum sector and at least no approach to develop same, and indeed, on the one hand, due to the easily available scroll pumps and, on the other hand, due to the pressure limit of the water vapor pressure previously caused by the principle. It has now been shown that the cost benefits of the rotary vane vacuum pumps can also be used in this application case, namely dry running in conjunction with fine vacuum generation.

### REFERENCE NUMERAL LIST

10 rotary vane vacuum pump
12 inlet
14 outlet
16 housing member
18 inner wall
20 pumping space
22 rotor
24 rotor member
26 vane
28 recess
30 pumping volume
32 outlet valve
34 outer housing
36 oil chamber
38 axis of rotation
40 region
42 region
44 guide region
46 guide region
48 abutment region
50 abutment region
52 guide region
54 guide region
56 closure wall
58 region
60 cooling ribs
61 region
62 support plate
64 plain bearing

1. A rotary vane vacuum pump comprising
a housing member whose inner wall defines at least one pumping space; and
a rotor that is arranged for rotation in the pumping space and has a rotor member and at least one vane,
wherein the vane radially projects beyond the rotor member and defines together with the inner wall of the housing member a pumping volume that can be pumped from an inlet to an outlet of the rotary vane vacuum pump by rotation of the rotor;
wherein, at least in a region cooperating with the inner wall, the vane comprises a polytetrafluoroethylene material containing polyimide particles and manufactured by hot pressing and sintering; and
wherein, at least in a region cooperating with the vane, the inner wall has a slide layer that comprises an oxide layer formed by anodic oxidation in an electrolyte containing oxalic acid.

2. The rotary vane vacuum pump in accordance with claim 1,
wherein the total vane is manufactured from the polytetrafluoroethylene material.

3. The rotary vane vacuum pump in accordance with claim 1,
wherein the total inner wall defining the pumping space has the slide layer.

4. The rotary vane vacuum pump in accordance with claim 1,
wherein the vane is displaceably supported in the rotor member and, at least in a region cooperating with the rotor member, comprises a polytetrafluoroethylene material containing polyimide particles and manufactured by hot pressing and sintering, with at least, in a region cooperating with the vane, the rotor member having a slide layer that comprises an oxide layer formed by anodic oxidation in an electrolyte containing oxalic acid.

5. The rotary vane vacuum pump in accordance with claim 4,
wherein the rotor member has a guide for the vane and the regions are cooperating guide regions.

6. The rotary vane vacuum pump in accordance with claim 4,
wherein the rotor member has an abutment for the vane and the regions are cooperating abutment regions.

7. The rotary vane vacuum pump in accordance with claim 1,
wherein a closure wall is provided that extends transversely to an axis of rotation of the rotor and axially bounds a respective pumping volume, with, at least in a region cooperating with the closure wall, the vane comprising a polytetrafluoroethylene material containing polyimide particles and manufactured by hot pressing and sintering, and with, at least in a region cooperating with the vane, the closure wall having a slide layer that comprises an oxide layer formed by anodic oxidation in an electrolyte containing oxalic acid.

8. The rotary vane vacuum pump in accordance with claim 7,
wherein the closure wall is part of the housing member.

9. The rotary vane vacuum pump in accordance with claim 7,
wherein at least one of the closure wall and a second closure wall is formed by a component separate from the housing member.

10. The rotary vane vacuum pump in accordance with claim 1,
wherein the housing member, the rotor member and/or the closure wall, at least in the region of the slide layer, comprises/comprise a base material that is at least partly formed from aluminum or an aluminum alloy and to which the slide layer is applied.

11. The rotary vane vacuum pump in accordance with claim 1,
wherein the rotary vane vacuum pump has a temperature regulating device for the pumping space.

12. The rotary vane vacuum pump in accordance with claim 1,
wherein the temperature regulating device is configured to maintain the temperature of at least one of the inner wall, the rotor body of the closure wall, and the vane in a temperature range in operation, with an upper limit of the temperature range amounting to at most 100° C., and/or with a lower limit amounting to at least 20° C.

13. The rotary vane vacuum pump in accordance with claim 1,
wherein the rotor is supported at at least one side by a plastic plain bearing.

14. The rotary vane vacuum pump in accordance with claim 1,
wherein the rotary vane vacuum pump is formed as two-stage.

15. The rotary vane vacuum pump in accordance with claim 1,
wherein the rotary vane vacuum pump is configured for dry running.

16. The rotary vane vacuum pump in accordance with claim 1,
wherein the rotary vane vacuum pump is free of a vapor pressure safety valve.
